(19) United States
(12) Patent Application Publication
(10) Pub. No.: US 2006/0203272 A1
(43) Pub. Date: Sep. 14, 2006

(54) Print accounting by embedded PDL comments

(76) Inventors: Manuel A. Manalo, Concord, CA (US); Zheila L. Ola, Pittsburg, CA (US)

Correspondence Address: Kyocera Technology Development;Intellectual Property Administration, Suite 400, 1855 Gateway Blvd., Concord, CA, 94520, US

(21) Appl. No.: 11/077,946

(22) Filed: Mar. 11, 2005

(51) Int. Cl. G06F 3/12; G06F 15/00

(52) U.S. Cl. 358/1.13; 358/1.14

(57) ABSTRACT

A method for communicating accounting information from a printer driver to an accounting system, wherein the printer driver inserts accounting information into a print stream, which is monitored by the accounting system. PDL comments contain per-page accounting information, obtained by the printer driver analyzing printing and drawing GDI and API functions. Methods include per-job cumulative accounting information in a separate log file; enabling monitoring by any accounting system cognizant of the accounting data formats; accounting color mode information, media type, layout, duplex, finishing option, imaging, output option, watermark, etc.; a color page contains at least a single color pixel, and determining a monochrome print object if red, green, and blue components are equal; and color mode detection comprising a parser to check for color commands in Passthrough data and presence of image data, checking JPEG header for number of components, whose value of 1 indicates monochrome, decompressing using decoder, and checking for R-G-B components.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to device drivers, and more particularly to an improved method of print accounting by embedded PDL comments.

### BACKGROUND OF THE INVENTION

Device drivers are generally known, including a printer driver. Typically, printing from a computer occurs through the use of a printer driver. Upon either an application launch or during a print command load time, the application will call an instance of the printer driver. Different printing features such as color mode, media type, and finishing options are associated with different costs, and keeping track of the accounting information can be complicated. There is a need for an improved method of analyzing accounting information, as well as a method of communicating accounting information from a printer driver to an accounting system. The present invention arose out of the above concerns associated with providing an improved method of print accounting.

### SUMMARY OF THE INVENTION

Methods, computer program products, computing and printing systems for communicating accounting information from a printer driver to an accounting system, wherein the printer driver inserts accounting information into a print stream, which is monitored by the accounting system. PDL (Page Description Language or Printer Description Language) comments contain per-page accounting information, obtained by the printer driver analyzing printing and drawing GDI and API functions. Methods include per-job cumulative accounting information in a separate log file; enabling monitoring by any accounting system cognizant of the accounting data formats; accounting color mode information, media type, layout, duplex, finishing option, imaging, output option, watermark, etc.; a color page contains at least a single color pixel, and determining a monochrome print object if red, green, and blue components are equal; and color mode detection comprising a parser to check for color commands in Passthrough data and presence of image data, checking JPEG header for number of components, whose value of 1 indicates monochrome, decompressing using decoder, and checking for R-G-B components.

The invention will be more fully understood upon consideration of the detailed description below, taken together with the accompanying drawings.

### DESCRIPTION OF THE DRAWINGS

FIG. 1 is a simplified block diagram showing connection of a computing system to a printer.

FIG. 2 is a block diagram showing the components of a print accounting system in accordance with a preferred embodiment of the present invention.

FIG. 3 is a block diagram showing the flow of print stream in a print accounting system in accordance with a preferred embodiment of the present invention.

FIG. 4 is a sample print stream containing embedded accounting information, in accordance with a preferred embodiment of the present invention.

FIG. 5 is a flowchart showing detection of color information in accordance with a preferred embodiment of the present invention.

FIG. 6 is a flowchart showing use of the log file, in accordance with a preferred embodiment of the present invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

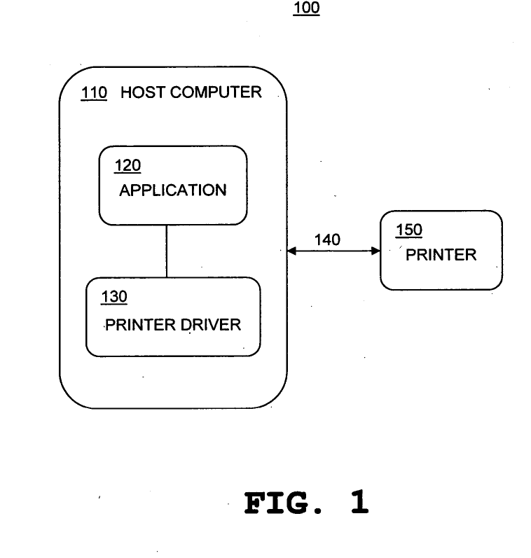

FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer driver settings, and it is also suited for other device drivers. The above explanations regarding FIG. 1 used a printer driver rather than a general device driver for concreteness of the explanations, but they also apply to other device drivers. Similarly, the following descriptions of the preferred embodiments generally use examples pertaining to printer driver settings, but they are to be understood as similarly applicable to other kinds of device drivers.

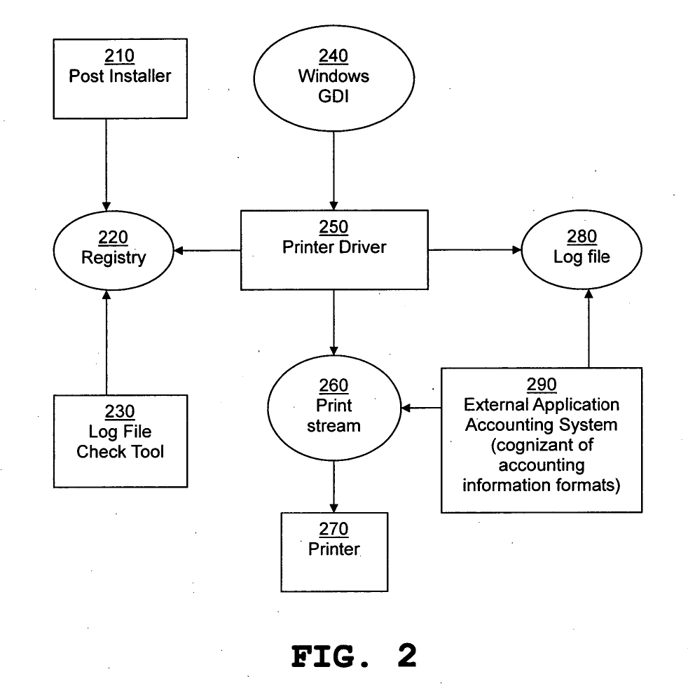

FIG. 2 is a block diagram showing the components of a print accounting system in accordance with a preferred embodiment of the present invention. In a preferred embodiment of the present invention, the color page counting feature is an add-on option in the printer driver. To enable the color page counting feature, a user runs the post installer 210 after driver installation. When a user selects this option, the post installer enables the color page counting feature by setting the registry entry 220.

Printer driver 250 checks the registry entry to decide whether to perform the accounting processing of the present invention. When the printer driver 240 processes Windows GDI calls 240 and other graphical directives, depending on the user setting specified in the registry 220, two additional processes can be performed in addition to the output of print stream 260. The print stream 260 can be an output to a file.

The first additional processing is the insertion of accounting information into the print stream 260. A print stream 260 goes to the printer 270 to cause the desired output. The inserted accounting information in the print stream does not affect the output, but is monitored and used by the external application accounting system 290. The accounting system can also be a part of the printer driver. The accounting system typically manages printed page counts classified by each type of feature used for each customer for charging or statistical purpose.

The second additional processing is the output of cumulative accounting information to a log file 280 if the driver determines that this feature is enabled by checking the registry 220 previously set by the log file check tool 230. The external application accounting system 290 may use the cumulative accounting information, when available, in conjunction with the accounting information in the print stream 260. The categories of accounting information include color mode information, media type, layout, duplex, finishing option, imaging, output option, watermark, etc. When printing a user is often presented with choices regarding where and how the output should be generated, i.e., the destination imaging device, as well as other choices, such as the desired type of print media, color or black & white, the desired resolution, the desired print density, etc. Different imaging devices often have differing capabilities, and many of the choices are limited or defined by the choice of destination imaging device. The user's choices regarding the destination and the manner of printing also affect the cost of the printing. This cost can be tabulated by the printing vendor to charge the customer, or it can also be used to inform the user by giving an estimate cost of printing either before, during, or after the printing. A cost-conscious user may desire to know the economic ramifications of the choices made, and an administrator of the imaging devices may want the user to be aware of such costs. The embodiments of the present invention facilitate providing economic feedback on the actual and estimated cost of producing an output. This requires knowledge of the cost variables of consumables, e.g., unit cost of the various types of print media, unit cost of the various types of marking material, unit cost of fasteners for binding multiple sheets of the print media, etc. The long-term cumulative accounting information can be used to inform the administrator on the wear and lifespan of the various expendable components that must be replaced, such as color toners, finisher and binding components, additional device wear from printing high-density images, etc. Any external application accounting system 290 cognizant of the data formats involved may monitor and use the accounting information in the print stream 260 and the cumulative accounting information in the log file 280. These processes are described in more detail below.

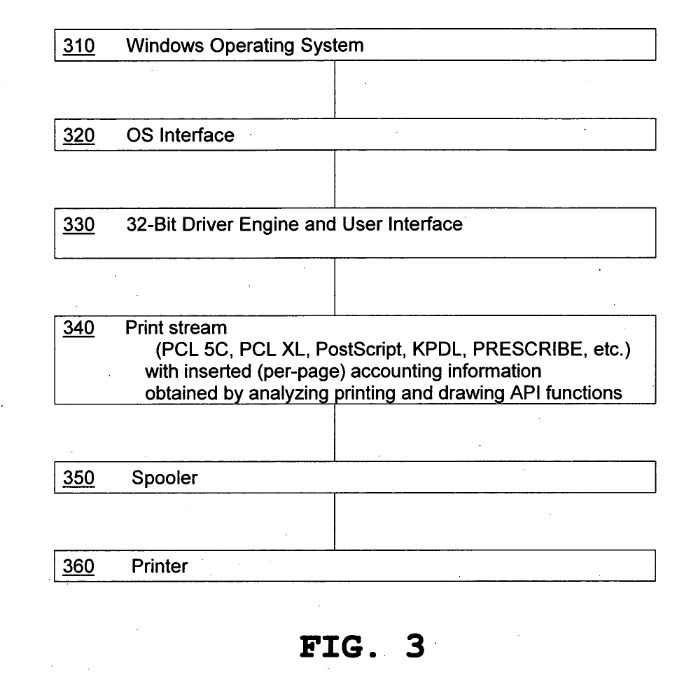

FIG. 3 is a block diagram showing the flow of print stream in a print accounting system in accordance with a preferred embodiment of the present invention. In an embodiment and architecture of the present invention, the accounting feature is implemented in the PDL side of the printer driver.

Windows operating system 310 provides an interface which includes a set of functions and structures to display graphical and text objects. This OS Interface 320 is known as the Graphics Device Interface (GDI) which the application uses to communicate with the printer driver through the 32-bit engine and user interface 330 provided in the driver.

When a document is printed using a printer driver, the application calls the driver using standard printing and drawing GDI functions. The driver processes these calls first in its core portion which handles operating system specifics, and then control is passed to the selected PDL (Page Description Language or Printer Description Language) module. The PDL module converts the drawing API function calls into commands which the printer can understand.

The sequence of calls which the PDL module receives for an n-page document is as follows:

StartDoc( )

StartPage( ), page 1 <Drawing functions for each print object> EndPage( ), page 1 . . .

StartPage( ), page n <Drawing functions for each print object> EndPage( ), page n EndDoc( ).

The driver checks the color page counting entry in registry. If the feature is enabled, the following steps are performed. For every print page (i.e. StartPage-EndPage pair), the color page counting process examines all print objects for color information to determine whether the page is color or monochrome. In an embodiment of the present invention, a print page is monochrome if all of its print objects are monochrome; otherwise it is a color page. Then color mode information is inserted into the print stream 340. Depending on the setting in the registry, other accounting information may also be inserted into the print stream. Other accounting information includes media type, layout, duplex, finishing option, imaging, output option, watermark, etc. At this time, cumulative accounting information may also be saved into the log file depending on the setting found in the registry.

After a print stream that includes the accounting information 346 is produced, it is the job of the print spooler 350 to send the print stream (or related files) to the printer 360. When the spooler completes sending the print stream to the printer, the spooler deletes the temporary file(s) holding the output.

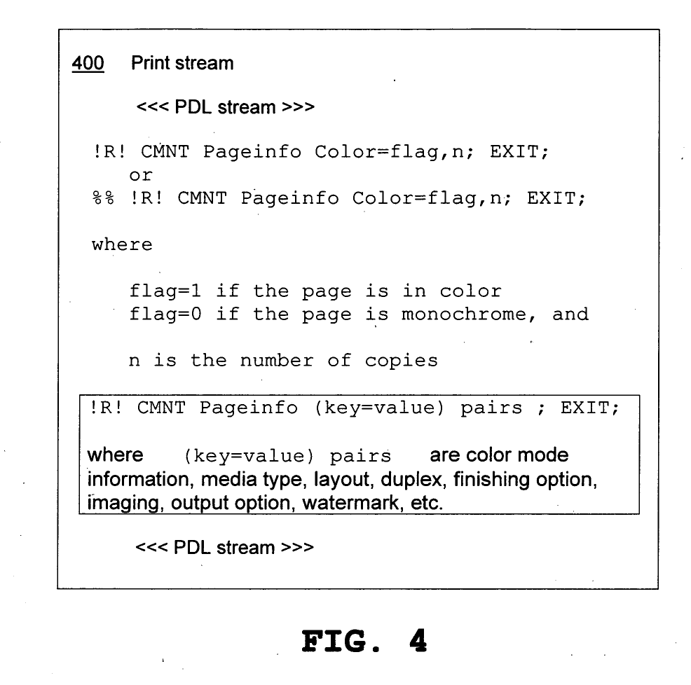

FIG. 4 is a sample print stream containing embedded accounting information, in accordance with a preferred embodiment of the present invention. A print stream consists of a series of PDL directives. Examples of PDL are PCL 5C, PCL XL, PRESCRIBE, KPDL, and PostScript.

When processing for a print page ends, a PRESCRIBE comment is embedded before the EndPage command is issued. A comment in PRESCRIBE is denoted by the string “!R! CMNT” in the beginning of a line. The syntax for a comment line for color accounting information is as follows: !R! CMNT Pageinfo Color=flag,n; EXIT; In this line, flag=1 if the page is color, flag=0 if the page is monochrome, and n is the number of copies.

The PRESCRIBE comment text above appears as is for PCL 5C. For PCL XL, it is contained within a PCL XL comment operator, while for KPDL, it is inside a PostScript comment, as follows: %% !R! CMNT Pageinfo Color=flag,n; EXIT;

More generally, the format of a comment line containing accounting information takes the following format: !R! CMNT Pageinfo (key=value) pairs; EXIT; In this comment line, (key=value) pairs are color mode information, media type, layout, duplex, finishing option, imaging, output option, watermark, etc. These categories of accounting information include those items that can be obtained by analyzing the standard printing and drawing GDI and API functions, which can be used to inform the user, administrator and/or the vendor in giving estimated or actual costs of printing. These comment lines do not affect printing but are monitored and decoded by the accounting system.

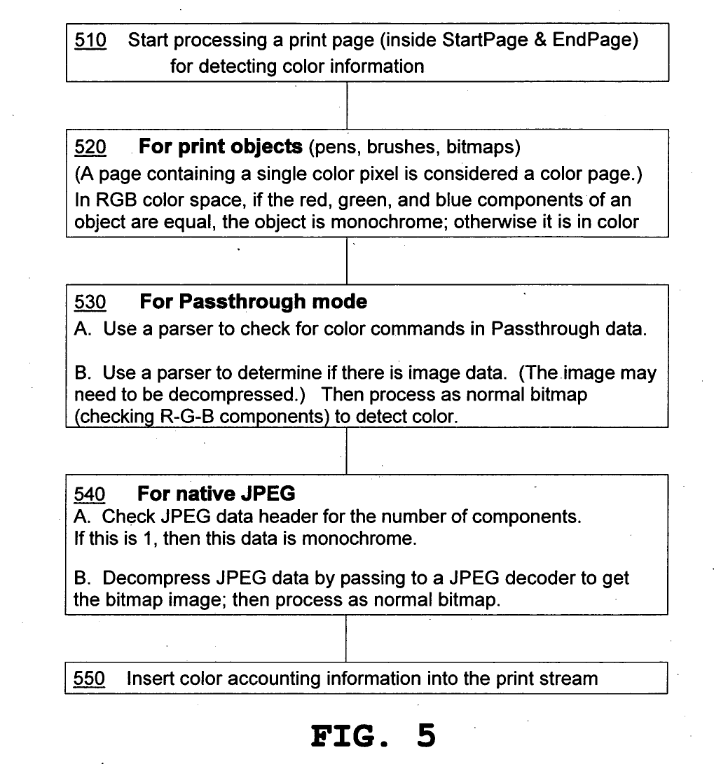

FIG. 5 is a flowchart showing detection of color information in accordance with a preferred embodiment of the present invention.

In step 510, the driver checks the color page counting entry in registry. If the feature is enabled, the processing for detecting color information while processing a print page is started. For every print page (i.e., StartPage-EndPage pair), the color page counting process examines all print objects for color information to determine whether the page is color or monochrome. In an embodiment of the present invention and in the following example, a print page is deemed monochrome if all of its print objects are monochrome; otherwise it is a color page.

In step 520, print objects in the page are processed. For the purposes of determining color information, the print objects can be classified into three categories: pens, brushes and bitmaps. The print objects are processed in the order in which they are received. Once a color print object has been found, processing for that particular page stops, and the page is marked as color. The process utilizes the RGB color space in determining whether a print object is color or monochrome. If the red, green and blue components of an object are all equal, then the object is monochrome; otherwise it is color. Print objects using pens include vector drawings such as lines, curves and polygons. The process simply checks if the pen is color or monochrome using its RGB components. Print objects using brushes include patterns and fills. Fonts and text belong to this group, as text color is rendered using a brush. The process simply checks if the brush is color or monochrome using its RGB components.

Bitmaps include various kinds of image data, and fall under two types: direct pixel (RGB) and indexed pixel. To determine if a bitmap is color, each pixel is checked for color information. A bitmap is color if at least one pixel is color; it is monochrome if all pixels are monochrome. A direct pixel bitmap has RGB pixels which can be readily checked. An indexed pixel bitmap has a color table as well as an array of indices to the color table, and each index represents a pixel. The process converts these indices into RGB pixels, which can then be checked.

In step 530, the page is processed for Passthrough mode support. (A) A parser is used to check for color commands in Passthrough data. Compare the color parameters in the color commands. If the color components are equal, the object is monochrome, otherwise it is in color. (B) A parser is used to determine if there exists an image data. If the image is compressed, this image must be passed through a decompression method (depending on the compression used) to get the uncompressed bitmap data; then process as normal bitmap, checking R-G-B components (similar to step 520) to detect color.

In step 540, the page is processed for native JPEG support. (A) The JPEG data header is checked for the number of components. If this is 1, then the image is monochrome, otherwise it is in color. (B) The JPEG data is decompressed by passing to a JPEG decoder to get the uncompressed bitmap image; then process as normal bitmap, checking R-G-B components (similar to step 520) to detect color. The parser and decoder can be part of the driver itself or could be a separate entity (outside of the driver).

In step 550, color accounting information obtained as a result of the above analysis and processing is inserted into the print stream. Depending on the other setting entries in registry, other accounting feature analysis and monitoring may be enabled, such as for media type, layout, duplex, finishing option, imaging, output option, watermark, etc. If so, these other types of information is analyzed and similarly inserted into the print stream.

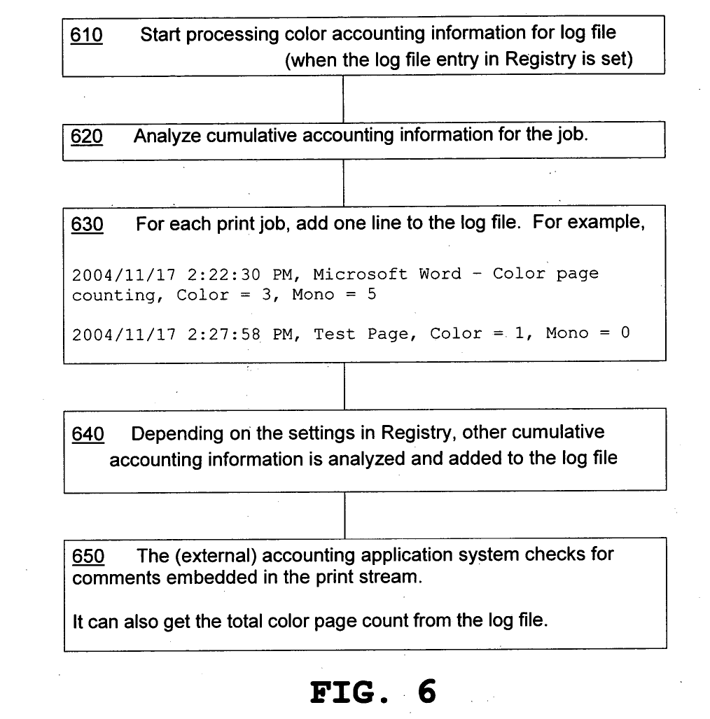

FIG. 6 is a flowchart showing use of the log file, in accordance with a preferred embodiment of the present invention. An optional log file may also be created to contain cumulative accounting information for each job, such as total page count information. This can be enabled by using a log file check tool. By checking the log file option, the log file entry in the registry is set. During processing, the driver checks this registry entry in step 610. If enabled, the driver creates an optional log file in the driver directory containing one line per print job and accounting information category. This flowchart shows the steps for processing color accounting information.

In step 620, cumulative color accounting information for the job is analyzed. The methods of analysis are described earlier.

In step 630, one line is added to the log file for each print job. The comma-delimited log data includes a date/time stamp, the job name, and the total count of color pages and monochrome pages for each print job. For example:

2004/11/17 2:22:30 PM, Microsoft Word—Color page counting, Color=3, Mono=5 2004/11/17 2:27:58 PM, Test Page, Color=1, Mono=0

In step 640, depending on the other setting entries in registry, other accounting feature analysis and monitoring may be enabled, such as for media type, layout, duplex, finishing option, imaging, output option, watermark, etc. If so, these other types of information is analyzed and similarly inserted into the print stream and added to the log file.

In step 650, the external accounting application checks for the PRESCRIBE comments embedded in the printable file and extracts the color page count per page. It can also get the total color page count for the print job in the log file.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although this invention has been largely described using Windows terminology, one skilled in this art could see how the disclosed methods can be used with other operating systems, such as DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A method of communicating accounting information from a printer driver to an accounting system, comprising: the printer driver inserting accounting information into a print stream, the resulting print stream operationally identical to the print stream before insertion of the accounting information; and the accounting system monitoring the print stream for the accounting information in the print stream.

2. The method of claim 1, wherein the accounting information in the print stream is a PDL comment, and wherein the accounting information is obtained by the printer driver analyzing printing and drawing API functions.

3. The method of claim 1, further comprising: the printer driver saving cumulative accounting information into a log file; and the accounting system monitoring the log file for the cumulative accounting information.

4. The method of claim 3, further comprising storing at least one accounting feature setting in a registry, wherein the accounting information in the print stream comprises per-page accounting information and the cumulative accounting information comprises per-job accounting information, and wherein the accounting information in the print stream and the cumulative accounting information in the log file enable monitoring by any accounting system cognizant of the format of the accounting information in the print stream and format of the cumulative accounting information in the log file.

5. The method of claim 1, wherein the accounting information comprises at least one key and value pair selected from the group consisting of color mode information, media type, layout, duplex, finishing option, imaging, output option, watermark, and any combination of these items.

6. The method of claim 1, wherein the accounting information is color mode information, wherein a color page is a page containing at least a single color pixel, and wherein a print object is determined to be not in color if the red, green, and blue components of the object are equal.

7. The method of claim 1, wherein the accounting information is color mode information, wherein color mode detection comprises: using a parser to check for color commands in Passthrough data; using a parser to determine if there is image data; and processing as bitmap image and checking for R-G-B components.

8. The method of claim 1, wherein the accounting information is color mode information, wherein color mode detection comprises: checking JPEG header for number of components, whose value of 1 indicates monochrome mode; decompressing JPEG data using JPEG decoder; and processing as bitmap image and checking for R-G-B components.

9. A computer program product for communicating accounting information from a printer driver to an accounting system, comprising machine-readable code for causing a machine to perform the method steps of: the printer driver inserting accounting information into a print stream, the resulting print stream operationally identical to the print stream before insertion of the accounting information; and the accounting system monitoring the print stream for the accounting information in the print stream.

10. The computer program product of claim 9, wherein the accounting information in the print stream is a PDL comment, and wherein the accounting information is obtained by the printer driver analyzing printing and drawing API functions.

11. The computer program product of claim 9, further comprising machine-readable code for causing a machine to perform the method steps of: the printer driver saving cumulative accounting information into a log file; the accounting system monitoring the log file for the cumulative accounting information; storing at least one accounting feature setting in a registry, wherein the accounting information in the print stream comprises per-page accounting information and the cumulative accounting information comprises per-job accounting information, and wherein the accounting information in the print stream and the cumulative accounting information in the log file enable monitoring by any accounting system cognizant of the format of the accounting information in the print stream and format of the cumulative accounting information in the log file.

12. The computer program product of claim 9, wherein the accounting information comprises at least one key and value pair selected from the group consisting of color mode information, media type, layout, duplex, finishing option, imaging, output option, watermark, and any combination of these items.

13. The computer program product of claim 9, wherein the accounting information is color mode information, wherein a color page is a page containing at least a single color pixel, and wherein a print object is determined to be not in color if the red, green, and blue components of the object are equal.

14. The computer program product of claim 9, wherein the accounting information is color mode information, wherein color mode detection comprises: using a parser to check for color commands in Passthrough data; using a parser to determine if there is image data; processing as bitmap image and checking for R-G-B components; checking JPEG header for number of components, whose value of 1 indicates monochrome mode; decompressing JPEG data using JPEG decoder; and processing as bitmap image and checking for R-G-B components.

15. A computing system comprising a print engine, programmed to communicate accounting information from a printer driver to an accounting system, comprising: the printer driver inserting accounting information into a print stream, the resulting print stream operationally identical to the print stream before insertion of the accounting information; and the accounting system monitoring the print stream for the accounting information in the print stream.

16. The computing system of claim 15, wherein the accounting information in the print stream is a PDL comment, and wherein the accounting information is obtained by the printer driver analyzing printing and drawing API functions.

17. The computing system of claim 15, further comprising: the printer driver saving cumulative accounting information into a log file; the accounting system monitoring the log file for the cumulative accounting information; storing at least one accounting feature setting in a registry, wherein the accounting information in the print stream comprises per-page accounting information and the cumulative accounting information comprises per-job accounting information, and wherein the accounting information in the print stream and the cumulative accounting information in the log file enable monitoring by any accounting system cognizant of the format of the accounting information in the print stream and format of the cumulative accounting information in the log file.

18. The computing system of claim 15, wherein the accounting information comprises at least one key and value pair selected from the group consisting of color mode information, media type, layout, duplex, finishing option, imaging, output option, watermark, and any combination of these items.

19. The computing system of claim 15, wherein the accounting information is color mode information, wherein a color page is a page containing at least a single color pixel, and wherein a print object is determined to be not in color if the red, green, and blue components of the object are equal.

20. The computing system of claim 15, wherein the accounting information is color mode information, wherein color mode detection comprises: using a parser to check for color commands in Passthrough data; using a parser to determine if there is image data; processing as bitmap image and checking for R-G-B components; checking JPEG header for number of components, whose value of 1 indicates monochrome mode; decompressing JPEG data using JPEG decoder; and processing as bitmap image and checking for R-G-B components.
